(19) United States
(12) Patent Application Publication
(10) Pub. No.: US 2015/0332220 A1
(43) Pub. Date: Nov. 19, 2015

(54) COMPUTER IMPLEMENTED AUTOMATED MEETING SCHEDULING METHOD

(71) Applicant: Matt Apprendi, New York, NY (US)

(72) Inventor: Matt Apprendi, New York, NY (US)

(21) Appl. No.: 14/713,584

(22) Filed: May 15, 2015

Related U.S. Application Data
(60) Provisional application No. 61/994,630, filed on May 16, 2014.

(51) Int. Cl. G06Q 10/10; G06Q 50/00

(52) U.S. Cl. CPC G06Q 10/1095; G06Q 50/01

(57) ABSTRACT

The invention relates to a computer implemented method for automatically scheduling a meeting. The said method includes an intelligent algorithm adapted for accessing an inviter information data as well as accessing a plurality of invitee information data. The inviter fixes an event schedule on behalf of the plurality of invitees. Then the said method compares the inviter information data and the plurality of invitee information data and find out a mutually available appointment date for the inviter and the plurality of invitees. Wherein, the said mutually available appointment date is based on the said comparison of the inviter information data with the plurality of invitee information data. Then finally the said method schedule an event based on the said mutually available appointment date.

### FIELD OF THE DISCLOSURE

The invention relates to a computer implemented method for automatically scheduling a meeting over a user computing device. More specifically, the invention aims to provide a method, meeting scheduler and computer program for users to schedule events on each other's behalf.

### BACKGROUND OF THE DISCLOSURE

The primary practical use of a calendar is to identify days: to be informed about and/or to agree on a future event and to record an event that has happened. Calendars are also used to help people manage their personal schedules, time and activities, particularly when individuals have numerous work, school, and family commitments. People frequently use multiple systems, and may keep both a business and family calendar to help prevent them from overcommitting their time.

Many software applications exist for scheduling meetings and organizing personal itineraries. However, these applications cannot write events/meetings to more than two calendars i.e. meeting organizer and attendee. Further, the existing software send event/meeting invitations through an email exchange with users/potential attendees who do not use the same scheduling software applications. This wastes otherwise meaningful time for the person who does not use such a software application but interacts with a scheduling software application that requires email correspondence.

Accordingly, an automated meeting scheduling method is needed that can solve the issue of securing meetings/events on a calendar with multiple attendees with minimal dialogue or correspondence between attendees.

### SUMMARY

Aspects of the invention are thus directed to a computer implemented automated meeting scheduling method.

More specifically, the present invention accesses the inviter information data when the inviter/user logs in the automated meeting scheduling method. Similarly information data of other users/invitees is accessed. An event schedule is fixed by the Inviter on behalf of Invitees using the automated meeting scheduling method based on information data. The information data obtained from Inviter and Invitees is compared and various mutual available appointment dates are identified. An event is scheduled based on the mutually available appointment date.

The said information data includes data retrieved from calendar events, contacts, social or work profiles, emails, messages, of users i.e. both Inviter and Invitees.

The mutually available appointment date includes a common calendar date which is free for the inviter as well as for the plurality of invitees; a date which is mutually agreed by the inviter as well as for the plurality of invitees.

The fixing of event schedule includes an event title, event duration, event time frame, or an event location.

Accordingly, a method, meeting scheduler and computer program product are provided for automated meeting scheduling. It is thus the object of the invention to schedule an event by Inviter on behalf of Invitees based on mutually available appointment dates.

It is further an object of the invention to automatically schedule an event based on information data of users i.e. Inviter as well as Invitees.

It is also an object of invention to schedule events with multiple Invitees/attendees with minimal dialogue or correspondence between Invitees.

It is also an object of invention to retrieve/utilize the information data gathered from users' calendar events, social or work events, emails, messages and the like.

This together with the other aspects of the present invention along with the various features of novelty that characterized the present disclosure is pointed out with particularity in claims annexed hereto and forms a part of the present invention. For better understanding of the present disclosure, its operating advantages, and the specified objective attained by its uses, reference should be made to the accompanying descriptive matter in which there are illustrated exemplary embodiments of the present invention.

### DESCRIPTION OF THE DRAWINGS

The present invention together with the above and other objects and advantages may best be understood from the following detailed description of the preferred embodiments of the invention illustrated in the drawings, wherein:

FIG. 1 illustrates a user computing device and an exemplary automatic meeting scheduling interface, according to various embodiments of the present invention;

FIG. 2 illustrates a flow diagram involving various exemplary steps for automatic meeting scheduling, according to various embodiments of the present invention;

FIG. 3 illustrates exemplary block diagram where invention utilizes information data to generate event schedules, according to various embodiments of the present invention; and

FIG. 4 illustrates a user computing device showing various automated meeting schedules for the user, according to various embodiments of the present invention.

Like reference numerals refer to like parts throughout the description of several views of the drawing.

### DESCRIPTION OF THE INVENTION

The exemplary embodiments described herein detail for illustrative purposes are subjected to many variations. It should be emphasized, however, that the present invention is not limited to a method, meeting scheduler and computer program. It is understood that various omissions and substitutions of equivalents are contemplated as circumstances may suggest or render expedient, but these are intended to cover the application or implementation without departing from the spirit or scope of the present invention.

Unless otherwise specified, the terms, which are used in the specification and claims, have the meanings commonly used in the field of scheduler software. Specifically, the following terms have the meanings indicated below.

The terms “a” and “an” herein do not denote a limitation of quantity, but rather denote the presence of at least one of the referenced item.

The terms “having”, “comprising”, “including”, and variations thereof signify the presence of a component.

The term “user computing device” refers to any electronic device such as computer, laptop, desktop, mobile phone, PDA and the like.

The term “Inviter” refers to a user that issues the invitation of an event.

The term “Invitees” refers to users that receive the invitation, guests, attendees and the like.

The term “Event” refers to meeting, assembly, gathering, appointment and the like.

A computer implemented automated meeting scheduling method cited as “AMS method” hereinafter, refers to a method, a meeting scheduler and a computer program.

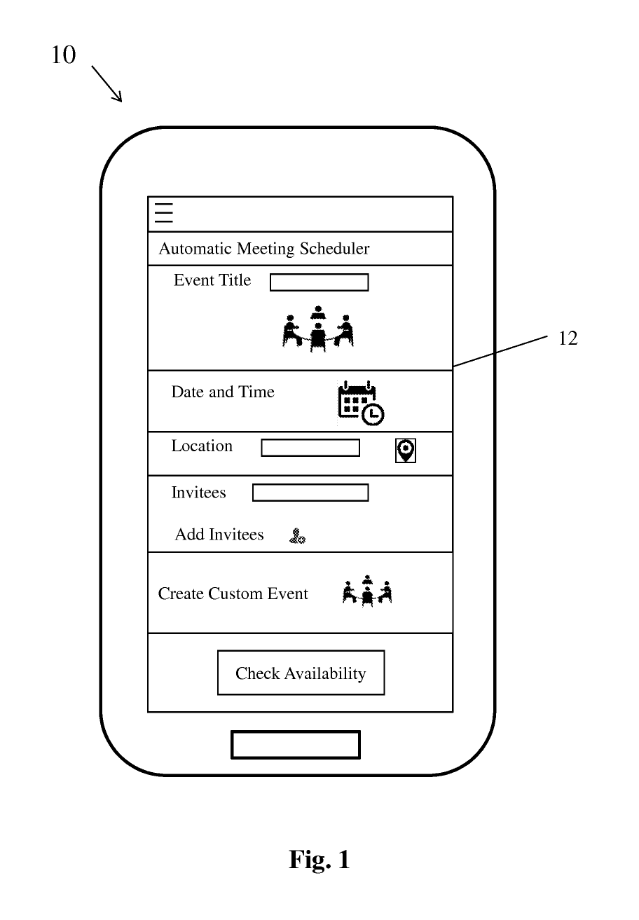

The invention will now be explained in conjunction with FIG. 1-4 as below.

Having reference to FIG. 1, there is shown a user computing device 10 with an interface of the AMS method on a display 12 of the said device 10. The present invention envisages the AMS as a software application not limited to a plug-in, mobile application etc., which will be apparent to a person skilled in the art, is described herein for allowing users to schedule events based on mutual coordination.

As shown in FIG. 1, the various icons/tools represent exemplary aspects to generate an event by the Inviter on behalf of the Invitees.

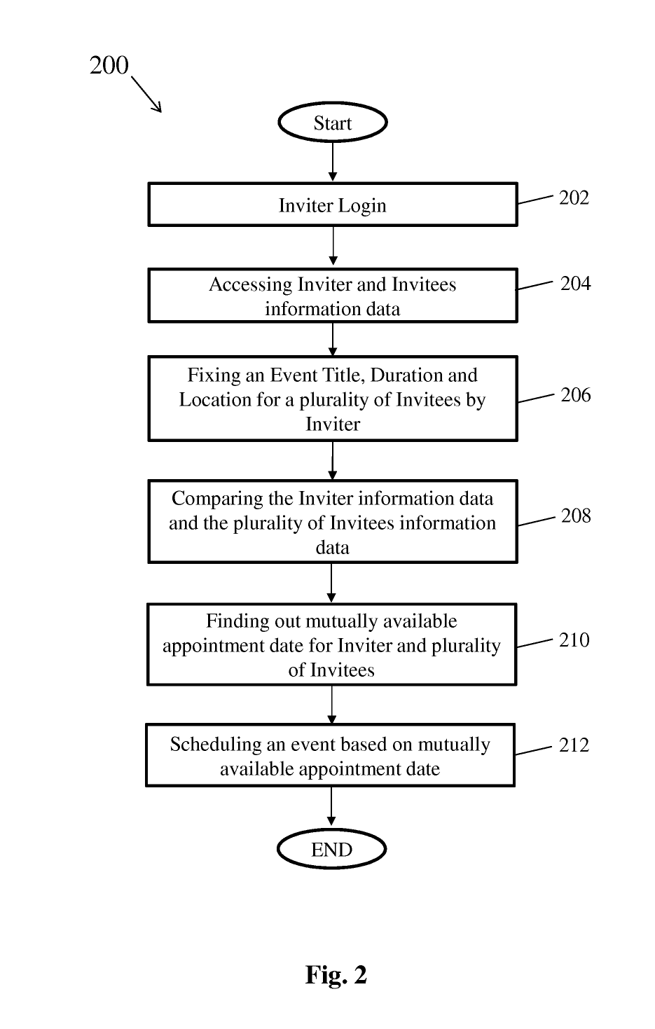

FIG. 2 illustrates an exemplary flow diagram for the computer implemented method 200 of the invention. At step 202 the user is asked to log in. After the user login, an interface is presented to the Inviter on the display 12 of the device 10, as shown in FIG. 1. The method 200 then at step 204 accesses the Inviter and Invitee information data.

In an embodiment of the invention, the inviter and invitees information data is accessed from the data present on a computing device of the inviter or invitees, data present on a social networking account of the inviter or the invitees, or virtual data of the inviter and the invitees.

In various embodiments of the present invention, the said information data includes data retrieved from calendar events, contacts, social or work profiles, emails, messages, virtual data from web portals, of users i.e. both Inviter and Invitees.

In one embodiment, the calendar event data related to the inviter comprises personal event manager of the inviter, social event manager of the inviter, or professional event manager of the inviter.

In another embodiment, the calendar event data related to each of the plurality of invitees comprises personal event manager of each of the plurality of invitees, social event manager of each of the plurality of invitees, or professional event manager of each of the plurality of invitees.

At step 206 of FIG. 2, the Inviter fixes an event through the interface on the display 12. An exemplary interface on display shows Event Title where the Inviter may enter the title of an event he/she wants to create. Date and Time option on the display 12 of device 10 help the Inviter to input a time slot, say 10 May to 20 May or 10 am to 5 pm of 10 May, when the Inviter wishes to conduct the said event.

The Location form enables the Inviter to input the location of the Event and Invitees can be added by “Add Invitees”. The Inviter can then check availability and identify mutually available appointments for the selected Invitees.

In an embodiment of the present invention, the Inviter can create a custom event by selecting “Create Custom Event” option displayed on the interface of device 10. Through this option an event can be created and invitations can be sent to selected Invitees.

After step 206, at step 208, the method 200 compares the information data obtained from Inviter with the information data of the selected Invitees. In an embodiment, the comparison of information data includes comparing of calendar event data of Inviter with calendar event data of Invitees. More specifically, comparing the inviter information data and the plurality of invitees information data includes comparing calendar event data of the inviter with calendar event data of each of the plurality of invitees, and comparing each of the of the plurality of invitees calendar event data with each other, wherein the said calendar event data is compared with and against the said event schedule.

In an implementation of the present invention, events or event schedules are retrieved from social networks, emails, text messages and the like, for identification of busy schedules and/or schedule free days of Inviter and Invitees.

After the information data is gathered at step 208, at step 210, the method 200 finds out mutually available appointment date(s). In an embodiment, mutually available appointment date is found by determining a common calendar date which is free for the inventor as well as for the Invitee.

In another embodiment, the mutually available appointment is a date which is mutually agreed upon by the Inviter as well as by the Invitee.

At step 212 of method 200, an event is scheduled based on the mutually available appointment. In an embodiment, the event is scheduled automatically if the event details are accepted by all Invitees. More specifically, finding the mutually available appointment date comprises finding a common calendar date which is free for the inviter as well as for the plurality of invitees, and a date which is mutually agreed by the inviter as well as for the plurality of invitees.

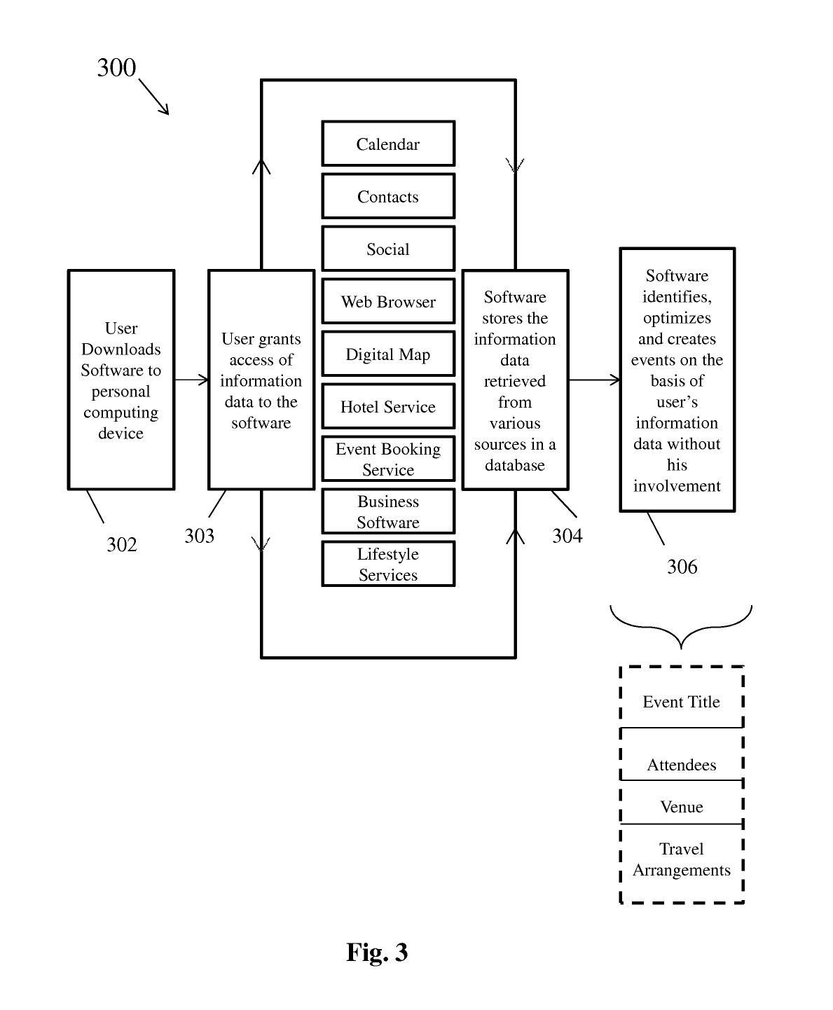

FIG. 3 illustrates a block diagram where the event is scheduled automatically without the user involvement. At 302 various users download the AMS plug in software on their computing devices, such as computing device 10. This enables all the users (inviters and invitees) to share information with each other.

As shown in FIG. 3, a user is shown to download the AMS plug in at block 302. Next is block 303, where a user grants access of information data to the software. This allows the software to get access to the computing device of the user. The information data is received from sources such as calendar, contacts, business software and the like of the user computing device.

In an embodiment, various dates such as birthdays, anniversaries etc. are extracted from the calendar of the user and deposited in a data repository of the computing device. The software is intelligent enough to determine the priorities of events. Say, the method knows user would be highly unlikely available on the birthday evening for other events compared to the user's availability on a day he wishes to take his car for service. Based on this data the AMS method may suggest a new event that can be completed along with the car service or can be scheduled in place of car service.

In another embodiment, the information data is collected from various social networking sites such as Facebook, and event data or details are extracted from these sites to create a busy and/or free schedule of the user. In an implementation, user's data is collected from web portals such as blogs etc., where an event is organized.

In another embodiment, more information data may be resourced from sources such as data from digital maps, lifestyle services, travel services etc. The information is collected to create an event.

At block 304, the AMS software stores all the information data relating to the user and identifies current as well as future events for the user. The software, at block 304, also stores information data of different contacts of the users as and when the contacts log in the AMS software. This data is then manipulated to identify the mutually available appointment dates for events.

At 306, events are created using the information data retrieved at block 304. In an embodiment, the events are created keeping in mind the user preferences. Say, a user conducted his last Event on Sunday at “The Grand Hotel” and booked a particular cab service, then as soon as the user is notified regarding a mutually available appointment date, he can schedule the next event based on his previous preferences and can notify other attending parties regarding the same. The event is presented to the user as an exemplary embodiment, block 308 shown in dashed line, presenting Event Title, no. of attendees, venue, travel arrangements etc.

Further, the AMS software may recognize a new event that will be completed in short span of time and insert this new event between events of less priority. In another embodiment, the software may ask the user to reschedule the events based on their priority, like birthday being more important than car service etc.

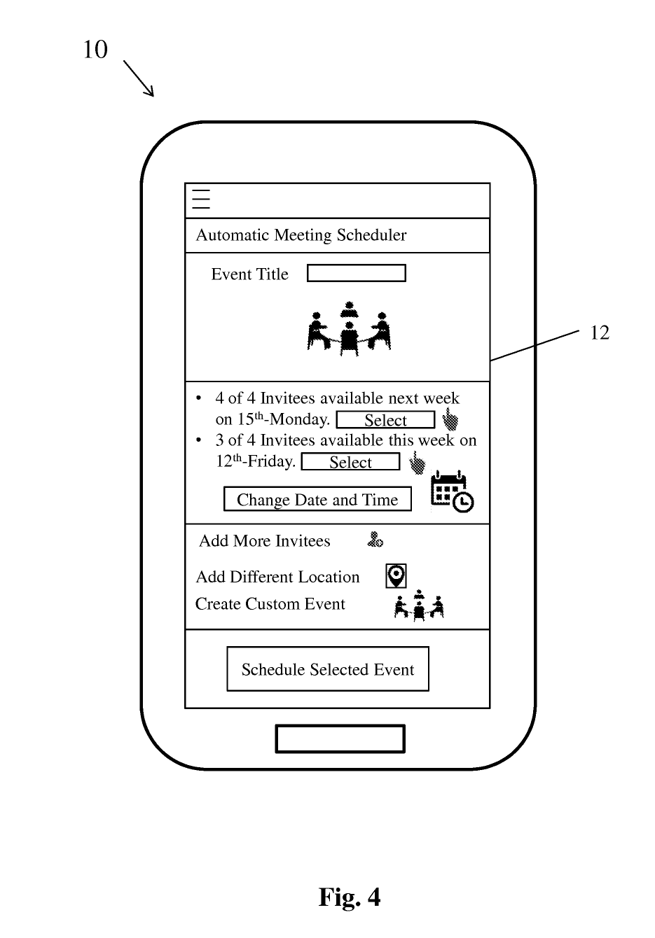

Accordingly, when the Inviter inputs various details of the Events in the interface of the AMS software in FIG. 1, various process steps as shown in FIG. 2 are executed and the Inviter is presented with different “Mutually available appointment” as shown in interface of the device 10 of FIG. 4.

In an exemplary embodiment, say the Inviter fixes an event that can take place between 12^{th} to 18^{th} day of a particular month. The Inviter also adds four people as Invitees and checks for their availability. The AMS software after executing steps 208 and 210 of 200 presents the Inviter various appointment dates available, as shown in FIG. 4.

Among the days selected by the Inviter, the method 200 identifies that 4 of all the 4 Invitees are available for the event on 15^{th} of the month, and 3 of 4 invitees is available for 12^{th} of that month. After the Inviter is presented with the following information, he/she can add/edit the Event details such as Tilte, date and time, Invitees etc. or create a custom event. If the Inviter wishes to continue the event, he selects the event of his liking by opting the “Select” button and “Schedule Selected Event”.

In this manner, the user is able to schedule events based on mutually available appointment dates. It should be understood that many variations of these embodiments are envisaged within the scope of the present invention.

The present system and method find wide applicability where a user is involved in areas such as marketing and sales. Following up with contacts is essential in such areas in real world. The system and method provide efficient and quicker way of keeping in touch with people across the world.

The system and method, as described in the disclosed teachings or any of its components, may be embodied in the form of a computer system. Typical examples of a computer system include a general-purpose computer, a PDA, a cell phone, a programmed microprocessor, a micro-controller, a peripheral integrated circuit element, and other devices or arrangements of devices that are capable of implementing the steps that constitute the method of the disclosed teachings.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer.

In a computer system comprising a general-purpose computer, such may include an input device, and a display unit. Specifically, the computer may comprise a microprocessor, where the microprocessor is connected to a communication bus. The computer may also include a memory. The memory may include Random Access Memory (RAM) and Read Only Memory (ROM). The computer system further comprises a storage device, which can be a hard disk drive or a removable storage drive such as a floppy disk drive, optical disk drive, and the like. The storage device can also comprise other, similar means for loading computer programs or other instructions into the computer system.

The computer system may comprise a communication device to communicate with a remote computer through a network. The communication device can be a wireless communication port, a data cable connecting the computer system with the network, and the like. The network can be a Local Area Network (LAN) or a Wide Area Network (WAN) such as the Internet and the like. The remote computer that is connected to the network can be a general-purpose computer, a server, a PDA, and the like. Further, the computer system can access information from the remote computer through the network.

It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatus configured to implement the method are within the scope of the present invention.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

What is claimed is:

1. A computer implemented automated meeting scheduling method for scheduling meetings between an inviter and plurality of invitees, said method comprising:
accessing an inviter information data;
accessing a plurality of invitees information data;
fixing an event schedule, the event being scheduled by the inviter on behalf of the plurality of invitees;
comparing the inviter information data and the plurality of invitees information data;
finding a mutually available appointment date for the inviter and the plurality of invitees, wherein the mutually available appointment date is based on the said comparison of the inviter information data with the plurality of invitees information data; and
scheduling the event based on the said mutually available appointment date.

2. The method as claimed in claim 1, wherein the inviter information data is accessed from the data present on a computing device of the inviter, data present on a social networking account of the inviter, or virtual data of the inviter.

3. The method as claimed in claim 1, wherein the inviter information data comprises personal data of the inviter, contact data of the inviter, or calendar event data related to the inviter.

4. The method as claimed in claim 1, wherein the inviter information data is calendar schedule of the inviter.

5. The method as claimed in claim 3, wherein the calendar event data related to the inviter comprises personal event manager of the inviter, social event manager of the inviter, or professional event manager of the inviter.

6. The method as claimed in claim 1, wherein the invitees information data is accessed from data present on a computing device of each of the plurality of invitees, data present on a social networking account of each of the plurality of invitees, or virtual data of each of the plurality of invitees.

7. The method as claimed in claim 1, wherein the plurality of invitees information data comprises personal data of the each of the plurality of invitees, contact data of each of the plurality of invitees, or calendar event data related to each of the plurality of invitees.

8. The method as claimed in claim 1, wherein the invitee information data is calendar schedule of each of the invitees.

9. The method as claimed in claim 7, wherein the calendar event data related to each of the plurality of invitees comprises personal event manager of each of the plurality of invitees, social event manager of each of the plurality of invitees, or professional event manager of each of the plurality of invitees.

10. The method as claimed in claim 1, wherein fixing the event schedule comprises compiling an event title, event duration, event time frame, or an event location.

11. The method as claimed in claim 1, wherein comparing the inviter information data and the plurality of invitees information data comprises:
comparing calendar event data of the inviter with calendar event data of each of the plurality of invitees, and
comparing each of the of the plurality of invitees calendar event data with each other, wherein the said calendar event data is compared with and against the said event schedule.

12. The method as claimed in claim 1, wherein finding the mutually available appointment date comprises finding:
a common calendar date which is free for the inviter as well as for the plurality of invitees, and
a date which is mutually agreed by the inviter as well as for the plurality of invitees.

13. The method as claimed in claim 1, wherein scheduling an event comprises at least scheduling a group of event activities for the inviter as well as for the plurality of invitees.

14. The method as claimed in claim 13, wherein scheduling the group of event activities comprises: scheduling a meeting date, scheduling a meeting time, scheduling a meeting location, scheduling a transportation mode, scheduling a hotel reservation, scheduling a restaurant reservation, scheduling a hospital reservation, or scheduling a salon reservation.
